(19) United States
(12) Patent Application Publication
(10) Pub. No.: US 2008/0057481 A1
(43) Pub. Date: Mar. 6, 2008

(54) Common Format Learning Device

(76) Inventor: William Charles Schmitt, Rochester, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/684,578

(22) Filed: Mar. 9, 2007

Related U.S. Application Data
(60) Provisional application No. 60/783,669, filed on Mar. 17, 2006.

(51) Int. Cl. G09B 3/00

(52) U.S. Cl. 434/350

(57) ABSTRACT

A common format learning device for teaching and learning commands to control electronic devices, appliances, applications, and user interfaces. The common format learning device provides a common form of presentation, a common user format, and a common translation of technical information across electronic devices, appliances, applications, and user interfaces. The common format learning device uses a relational structured chart format combined with terminology definitions, a listing of operations and suboperations, color recognition, and a glossarydex search engine.

### CROSS-REFERENCE TO RELATED PATENT APPLICATIONS

This application claims the benefit of the filing date of U.S. Provisional patent application Ser. No. 60/783,669 filed on Mar. 17, 2006.

### BACKGROUND OF THE INVENTION

1. Field of the Invention

This invention relates generally to education and demonstration, and more particularly to a common format learning device for teaching and learning commands to control electronic devices.

2. Description of Related Art

In modern times there has been a proliferation of electronic devices, appliances, and software, all of which have a user interface. Every machine from microwave ovens to cell phones to DVD players to automobile control panels are electronically controlled today, and they fail the user in the transmission of rightful, accurate and necessary knowledge to solve the user's ability to properly use the devices to their fullest.

There is no continuity to the way in which manufacturers, developers, designers and others use outdated teaching methods to develop the necessary high technology device interfaces that are a part of the present day array of electronic devices that humans interact with. In addition, the man-machine interface is not consistent across devices. Because there is no continuity to the way in which humans communicate with these various electronic interfaces, there is very little intuitive knowledge gained in our daily interaction with these devices, causing inefficiency and frustration on the part of the user. Many people struggle to function with electronic devices and their disparate and disaggregated random approach to learning. This disparity causes the user to get far less functionality from the device than the manufacturer or developers envisioned during product development.

It is therefore an object of the present invention to provide to a user a common form of presentation of almost any electronic device, application, or user interface. It is another object of the present invention to provide to a user a common translation of an electronic medium into easy to understand, user friendly operations. It is another object of the present invention to provide to a user a common user format across all electronic devices, applications, and user interfaces. These and other objects of the present invention are described in the detailed specification and the claims that are contained herein.

### SUMMARY OF THE INVENTION

A common format learning device for learning commands to control electronic devices comprising a glossarydex search engine containing an indexed listing of topics, a listing of definitions whereas each definition is linked to at least one topic in the glossarydex search engine, a listing of operations whereas each operation is linked to at least one topic in the glossarydex search engine, a listing of sub-operations cataloged below each operation whereas each listing of sub-operations is related to the operation under which the sub-operation is cataloged, and color coding of topics, definitions, operations and sub-operations, glossarydex and column headers.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

The invention will be described by reference to the following drawings, in which like numerals refer to like elements, and in which;

FIG. 1 is a flowchart depicting the current state of learning;

FIG. 2 is a flowchart depicting learning using the common format learning device of the present invention;

FIG. 3 is a block diagram representation of the components of the common format learning device of the present invention;

FIG. 4 is an example of the common format learning device using Kodak EasyShare Software.

FIG. 5 is an example of the common format learning device using the “Watermark” function of Microsoft Word.

FIG. 6 is an example of the common format learning device using Quicken Personal Finance Software as an example.

FIG. 7 is an example of the common format learning device using a Microwave oven electronic interface as an example.

FIG. 8 is an example of the common format learning device using an all in one copier electronic interface as an example.

FIG. 9 is an example of the common format learning device using a cell phone electronic interface as an example.

The present invention will be described in connection with a preferred embodiment, however, it will be understood that there is no intent to limit the invention to the embodiment described. On the contrary, the intent is to cover ail alternatives, modifications, and equivalents as may be included within the spirit and scope of the invention as defined by this specification and the claims herein.

### DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

The common format learning device of the present invention works in cooperation with an electronic device's user manual to assist the user in learning commands necessary to control, operate or otherwise interact with the electronic device. The present invention provides a common form of presentation of almost any electronic device application or user interface, and provides a common translation of this electronic medium into user friendly operations. The present invention will enable almost any user to become conversant with any electronic device that the user interacts with. The present invention uses a common format and structure across all devices and allows users to become familiar with and gain intuitive skills and insight about their electronic devices.

The Common Format Learning Device of the present invention allows the user to learn and use commands necessary to control, operate, maintain, troubleshoot, or otherwise interact with the electronic device, to the exclusion of any other references. The present invention is for people who need to know more technology operations in order to continue personal progress and be comfortable in the ever evolving technologies used by business, industry and government.

The Common Format Learning Device of the present invention overcomes the inability of users to easily and correctly understand the logic of the inventor of the technology that the user is working with. The present invention does this by bringing into view parts or elements of applied technology that are based on human logic and are memory based, but are normally not perceptible.

The present invention is a common format learning device that includes a methodical guide of using almost identical chart forms with a uniform base for presentation of electronic technology operations. The present invention eases memory retention by incorporating individual steps that emulate the original losic of the inventor or designer of the technology. The present invention makes life easier for those people who are able to use a manual guide to be able to make things work, get results and satisfy their “need”.

Some examples of typical electronic devices that may use The Common Format Learning Device of the present invention include:
Appliances such as microwave ovens, television sets, remote controls, home theatres.
Computers and all types of software applications and peripherals.
Food industry applications such as processing controls, automatic cooking controls, Imaging—digital photo and video cameras, science applications.
Industry, Commerce and Government applications such as electronic business records, electronic database and file storage, and the like.
Medical applications such as human health, body surveillance, imaging, x-rays and Magnetic Resonance Imaging, record keeping.
Telecommunications applications such as cell phones, test equipment, and the like.

The Common Format Learning Device of the present invention uses the programmers' logic transformed into a vernacular for teaching and learning. The present invention brings into its application the foreign logic of the programmer through a series of logical steps which the user can easily follow and understand. For any technical terms, the Glossarydex is a part of The Common Format Learning Device, and supplies exact definitions for the user. The components of The Common Format Learning Device, including the Glossarydex, will be fully explained by way of this specification.

The Common Format Learning Device of the present invention is a tool that may be modified by a designer of the specific advanced electronic technology. The Common Format Learning Device has more exact learning attributes to satisfy human needs than most other teaching/learning systems for electronic technology operations, and further provides for highly efficient knowledge transfer.

The Common Format Learning Device of the present invention is interactive, emulates the basic technology that it describes by using a uniform guidance system in a chart format, provides for stand alone operations, is memory targeted, uses color recognition, defines technology terminology, supports exact operations, is both teacher and learner based, promotes multi-tasking, is of the highest accuracy, is up to date with basic technology, minimizes user time and motion, is easily adaptable to foreign languages, uses a minimum of words, uses a maximum of icons, graphics, and photos to convey the information, and can easily “teach by example”.

The present invention is a common format learning device that includes methods of teaching and learning to instruct and reinforce the process of learning in areas such as computer software, so the user of the present invention obtains the highest degree of computer software knowledge in the shortest period of time. The Common Format Learning Device produces a very high degree of knowledge retention as a result of the highly repeatable and accurate methods of the present invention. In practice the user spends almost all of their time actually using The Common Format Learning Device of the present invention in conjunction with “hands on” activities in front of the device, for example, a computer keyboard, mouse or audio instructions. This “hands on approach” provides for the most efficient and accurate method for saving time and motion and committing the activity to human memory.

The Common Format Learning Device of the present invention is presented in chart format and contains two parts, the Definitions (what) and the Operations (how to), both of which are contained in a search engine called the Glossarydex. Every step of an operation using The Common Format Learning Device is an interaction between a software and hardware system and a user's response.

The Common Format Learning Device of the present invention presents a novel and unique approach to formatting any software language. The Common Format Learning Device is used to bring the complexities of invisible computer software into the vernacular so the eye can transmit to the mind what is invisible in order to make it visible. The Common Format Learning Device allows users to expand their knowledge beyond their present limits. The Common Format Learning Device works in conjunction with human logic.

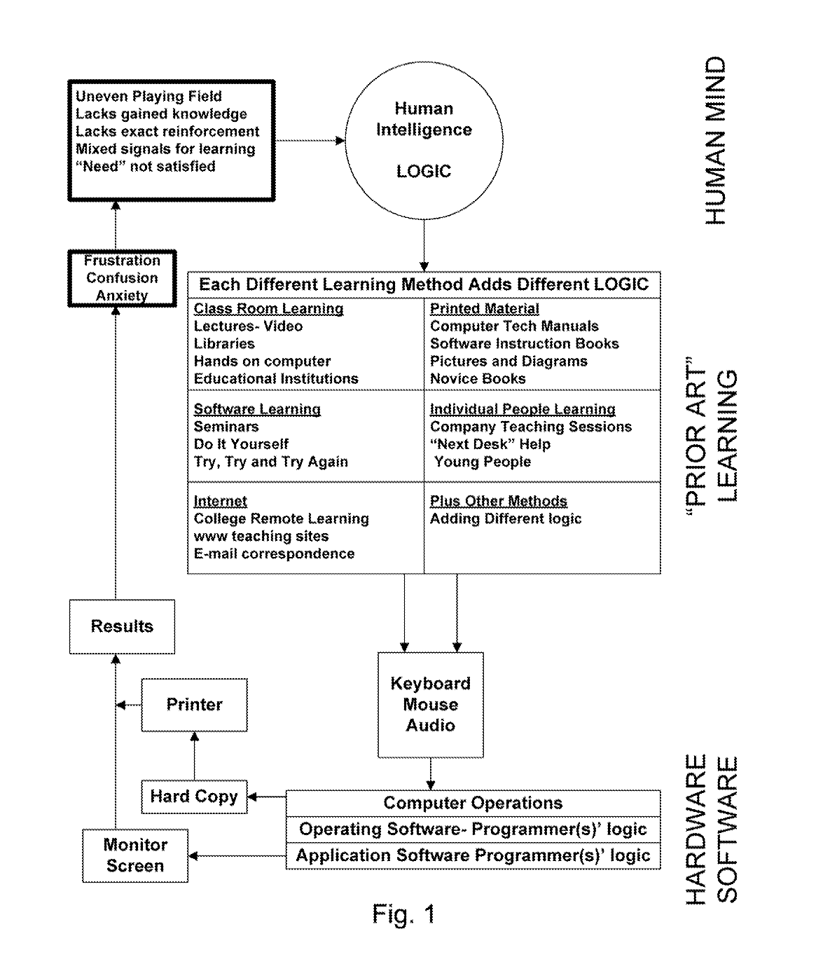

Referring to FIG. 1, a flowchart depicting the current state of learning is illustrated. In FIG. 1, the various forms of learning, including class room learning, printed material, software learning, individual people learning, internet and other methods of learning, are illustrated as they are applied to, as an example, a computer system. Using these various types of learning with electronic devices, such as computers, where there is disparity between the computer operations, the operating software, and the applications software, creates frustration, confusion and anxiety for many users. The flowchart in FIG. 1 exemplifies the problems with our current methods of learning when applied to electronic and software based devices.

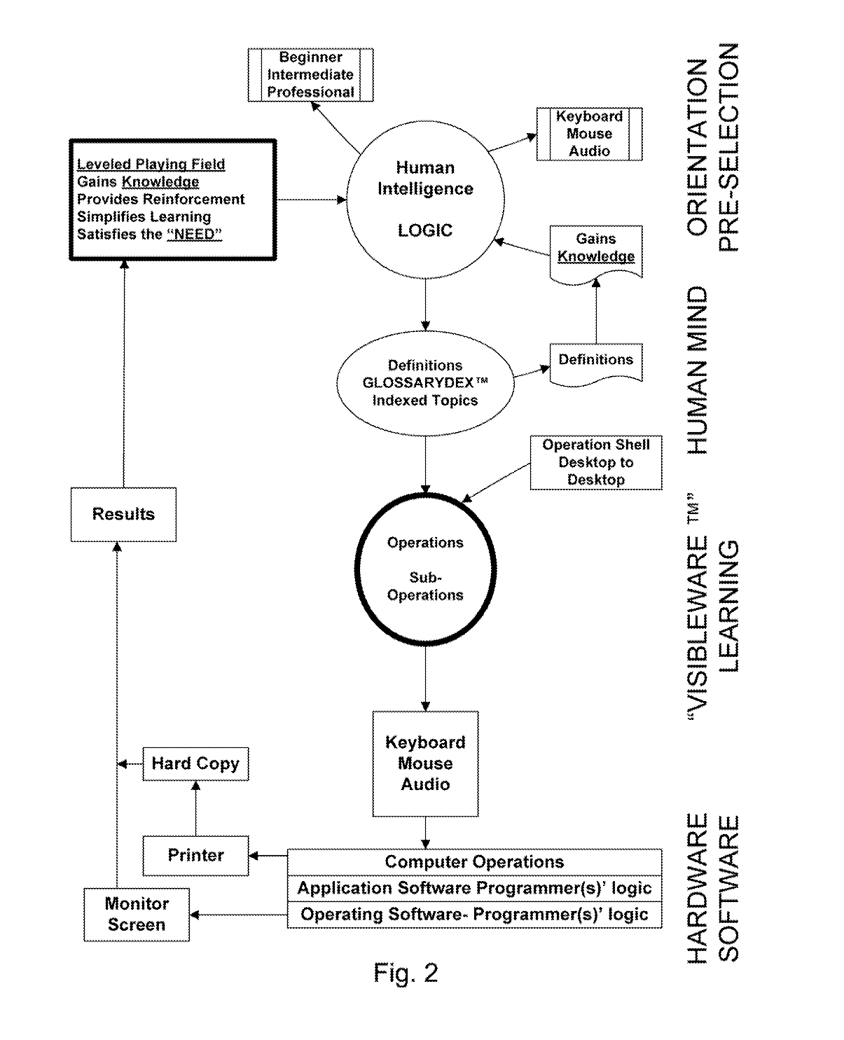

Now referring to FIG. 2, a flowchart depicting learning using the Common Format Learning Device of the present invention is depicted. The interaction of human intelligence and logic with the components of the common format learning device of the present invention is illustrated. The Glossarydex search engine, definitions, operations, and sub-operations function cooperatively through the common format learning device to provide the user with clarity and understanding of computer operations, the operating software and the applications software.

The design of The Common Format Learning Device of the present invention considers the fact that computer electronic software is a high tech, detailed and complex subject. Most individuals are not oriented for such unseen details and therefore they are generally unable to easily understand what makes software do what it does. A user is often not interested in how the software works. A user typically desires to satisfy their need to perform an operation using software and/or hardware in the simplest, most straight-forward manner possible.

The Common Format Learning Device of the present invention allows the user to extend their potential software knowledge far in excess of their imagined limits. The longfelt need for the present invention is evident by the widespread ignorance of the majority of software features and functionality contained in today's software products. The user simply is not aware of many of the functions contained in a software/hardware product, and has no easy way to either learn about these functions or to find a specific function that they are interested in using.

To draw an analogy, in 1979 Jeff Raskin of Apple Computer® tried to simplify the computer user's experience, focusing on a faster and more logical interface. He invented the Macintosh®, with a simpler computer interface. Today a more logical software interface is The Common Format Learning Device of the present invention.

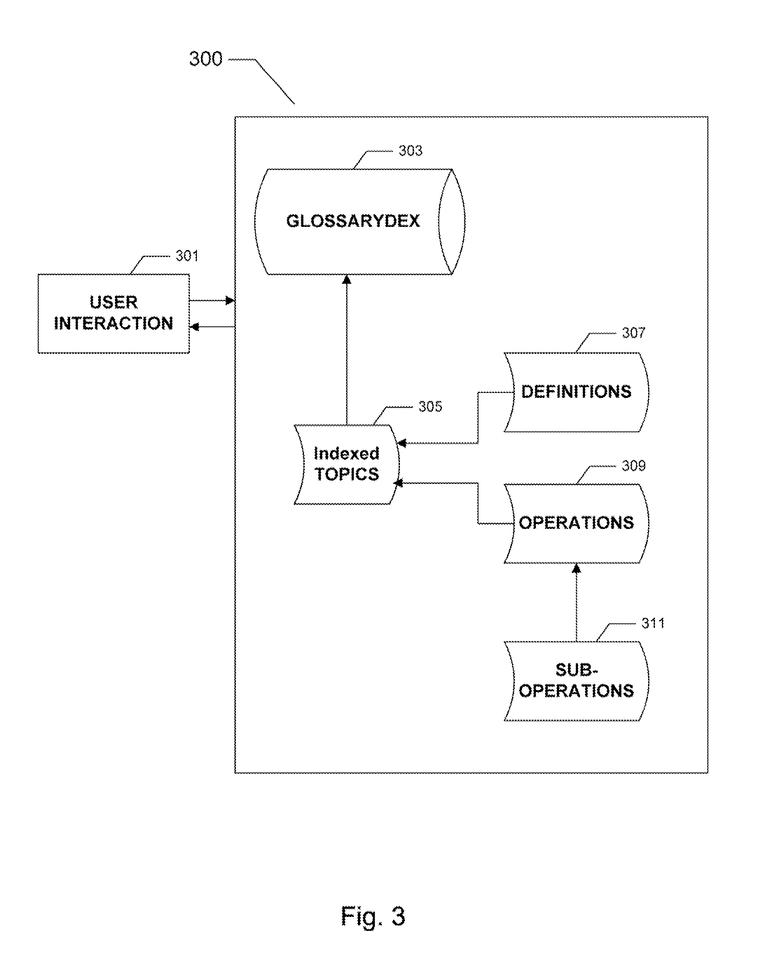

Turning now to FIG. 3, a block diagram representation of the components of the Common Format Learning Device 300 are shown. The common format learning device as a whole provides user interaction 301 to achieve the useful result of learning commands to control electronic devices. The Glossarydex 303 is ordered in a structured format, such as alphabetical order, similar to an Index, but contains a great deal more information. The Glossarydex is a search engine which leads to indexed topics 305 where the definition 307, operation 309 and sub-operation 311 are located together, with all the information the user requires to do their work in one location, providing complete and straightforward information access. For example, if the Glossarydex topic is “Document”, the Glossarydex search may have sub-operations of: 1.) Create a new document, 2.) Edit a document, 3.) Faxing a document, 4.) Formatting a document, 5.) Printing a document, 6.) Saving a document, and 7.) Copy items between documents. Computer software use is typically memory based, therefore the only thing the user needs to remember is where to find the subject in the Glossarydex 303.

Again referring to FIG. 3, Definitions 307 are essential for understanding computer and software technology. Definitions are taken from new technical dictionaries such as Webster's New World Dictionary of Computer Terms and Barron's Dictionary of Computer and Internet Terms, with other generated terms as close as possible to an understandable explanation of the definition. Defined terms help users better understand the words describing this relatively new technology. Many of the definitions are really a “need to know” explanation to allow the user to understand what they are doing and to proceed with knowledge that is necessary for proper operations of the subject software and/or hardware.

Definitions 307 are cross-indexed so that a user's memory may hit on another synonymical word in place of a more readily acceptable one. For example, the word “document” might be cross indexed with letter, memo, pamphlet, epistle, note, letter, post card, etc. Definitions contain words, phrases, synonyms, cross index, icons and pictures to transfer knowledge to the user in the simplest manner. Because there are so many different methods of teaching and learning available today, the use and misuse of computer software definitions is a burgeoning problem that creates confusion and impedes proper learning.

The Operations section 309 is where a user finds, learns and later reinforces the subject so as to gain knowledge of the subject and ultimately solve their needs. The Main Menu is where all the actions start, and the necessary Common Format Learning Device instructions follow in line to take the user to the definition of the operation and then to the start of the operation (both are located together). The Common Format Learning Device guides the user through the entire operation by use of a chart form with a minimum of words. Then The Common Format Learning Device returns the user back to the Main menu. It is the operation itself that satisfies the users' “need”. Following along after the operation 309 are sub-operations 311 which are related and a further extension of work already done on the operation 309. For example: “Document” is contained in operations 309, and “Printing” is contained as a sub-operation 311. Printing is quite often used right after the document is completed. Any application software will include user support as needed, with portions of the system software required to seamlessly work into the application.

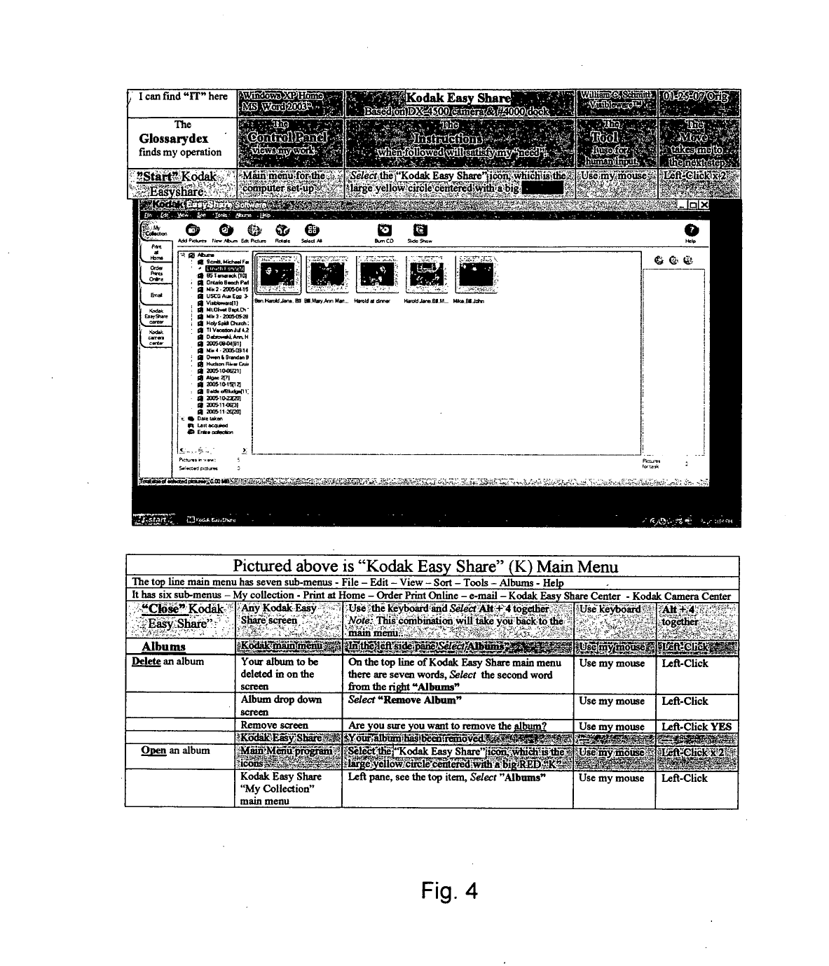

Referring now to FIGS. 4 through 9, examples of The Common Format Learning Device are shown. Each one of these examples follows a common chart format. FIGS. 4 through 9 are representative examples only, and are not meant to in any way limit the scope of the present invention. This common chart format is further explained through the sample chart structure depicted below and the description that follows.

| I Want to find IT | | | | | | Execute |
|---|---|---|---|---|---|---|
| to satisfy my need | Monitor/Screen | Visibleware ™ Explanation | | | I must . . . | Command |
| Glossarydex | View of Operations | Instruction | Information | Reference | Human Input | System |
| | | Definitions | Operations | Results | | operations |

The Glossarydex (1^{st} Column) is an A to Z search list to find the definition or operation that leads to the solution and knowledge to be gained.
The Monitor/Screen (2^{nd} column) is your desktop work space where you see your work as you do it, and the results of your actions.
The Instruction (3^{rd} column) is the heart of the chart which gives the user instructions, references, and information necessary to satisfy the “need”. The results of all the given instructions in column three are shown on the screen or hard copy from the printer.
Human Input (4^{th} column) tells the user what physical actions and instructions it must give to the computer, using the mouse or keyboard.
The Execute Command (5^{th} column) is where the user must take necessary action to activate the system to continue “work in process” or get the final results and acquire the knowledge to satisfy the “Need”.

Emulating the software is the key to the present invention's direct approach and the illuminator that allows the user to follow the unseen path the programmer has set. Computer software is programmed line for line from start to finish in it's own language such as Cobol, APL, Fortran, etc. and today is usually activated through menus. If it were not for the fact that people can read the menu in their own native language, software would still be only in the programmer's domain.

Chart Format is used almost exclusively for ail of the present invention's work. Operations use sentences, statements Italics, underline, color lettering, Color background, bold, icons, pictures, graphics and additional methods to be accurate, pin point the work and keep the user's mind concentrated on the subject. The verbiage is kept to a minimum which allows the mind to easily assimilate the definitions and operations. Chart format is a typical “Word Picture” of operations so that the human mind can better see and understand what is taking place, to solve their “needs”. The Chart Format is not exclusive, but a typical application, such as the chart format shown in the “Windows Word” examples provided later in this specification. In some embodiments of the present invention, the chart may contain more or fewer columns and hidden control columns.

A Programmed Vernacular Language is used by The Common Format Learning Device of the present invention to bring the complexities of computer hardware and software in view so that the human eye can transmit to the mind the information contained in invisible software, allowing this information to become visible in the native language of the user. The Common Format Learning Device language is composed through the formatting of color, bold, italics, underline, icons, photos, and other human concentrating applications that provide for attention concentration. A team of individuals proficient in technical software, native speaking, printed language, and human logic, using the methods contained or implied in The Common Format Learning Device can produce many other teaching/learning program applications. The Common Format Learning Device has applications in most technical products.

Stand Alone Operations are suited to the fast, pace of today's world as each operation is brought up and used only as the user has use for that type of work. No listening to a whole lecture or reading a whole book only to find the one operation that's needed. Just search for the information in the Glossarydex. There is only one operation given to solve the user's “need”, not several to confuse the human mind.

Sub-Operations are minor operations listed directly after the main Operation, The user is not required to look in other parts of a book to find related operations. For example, if a main operation is “Printing”, then directly after this listing in alphabetical order are the Sub-Operations: Canceling, Draft, Output, Documents, Envelopes, Fax cover sheets. Pausing, Queue, Selected Text, Watermarks, and Web Pages.

Color and the widespread use of color in the present invention is vital. Color is used extensively to lead the human eye to convey to the mind the various parts of the present invention so the user knows where and what they are doing. All Definitions and Operations are clearly text and color marked. The six color orientations are shown as follows;

| COLOR A | COLOR B | COLOR C |
|---|---|---|
| GLOSSARYDEX is | DEFINITIONS are for | OPERATIONS are |
| more than and index | common words of more | individual instructions |
| or a glossary. It is | than one meaning, and | the user takes to satisfy |
| made to answer | the one that most clearly | their need. Unusual is |
| your “needs”. | applies to software. New | the fact that the main |
| It is alphabetical, | computer terms are taken | operation can be |
| uses synonyms, | from computer | followed by related |
| acronyms, cross | dictionaries, with editing, | sub-operations to make |
| index, icons, | to more understandable | continuity of the user's |
| pictures, color, or | regular words when | work much easier. |
| any other method | possible. | |
| that makes it | | |
| easier for the | | |
| user to satisfy | | |
| their need. | | |
| COLOR D | COLOR E | COLOR F |
| DESKTOP TO | PAGE HEADERS are | A–Z MARKERS are |
| DESKTOP is where | used on every page to | just like in your |
| the user always | quick reference to what | dictionary or telephone |
| starts, proceeds | each column is used for. | book. They take the |
| through the entire | | user quickly to the spot |
| operation, satisfies | | they are looking for. |
| the user's need | | |
| and returns the user | | |
| to Desktop. | | |

Color research and the relationship between color and the human eye and mind has shown that color accelerates learning by up to 78%, raises readership by up to 40% and increases comprehension by up to 73%. These facts have been stated in the “The Power of Color” by Virginia Johnson, published in “Successful Meetings”, June 1992, “Business Papers in Color. Just a Shade Better”, published in “Modern Office Technology”, July 1989 and “The Persuasive Properties of Color”, published in “Marketing Communications”, October 1984. The present invention makes extensive use of color to facilitate the learning and comprehension process.

Knowledge gained through use of The Common Format Learning Device is the result of thorough and accurate learning, which provides for the greatest resolution of the users “needs”.

Concentration is the main focus of different parts of the charts used in the present invention. The charts make it as easy as possible for the user to complete their own work with the least effort in time and motion. The ability of the user to get into the software where their work is located is essential, followed by performing their own detail work. The act of getting to their own work and returning is by way of a Main Menu to Main Menu function.

Accuracy is of utmost importance to The Common Format Learning Device. Seeing, thinking and acting on the desired operation correctly, and then correctly repeating it exactly as it is given the first time, leads to accurate and sure knowledge of the operation. With The Common Format Learning Device of the present invention, only one way to perform an operation is learned for each operation. This avoids confusion and filling the mind with a lot of unnecessary approaches. The Common Format Learning Device of the present invention allows the user one method to stick with.

Visible and legible instructions are shown at every step in using The Common Format Learning Device, so the user can follow instructions and use their eyes to transmit information to their mind, with their “hands-on” the computer, to quickly satisfy their “need” to understand and complete a task. To learn computer software the user must have an understanding of what they are doing and what and how the different functions they are performing can be turned from frustrations into the reality of proper learning. The Common Format Learning Device makes it easy for a user to repeat the same operations, a fundamental aspect of learning.

Reinforcement of the exact learned operation is often and frequently necessary due to memory slips of humans, especially when long time lapses occur between uses. A quick reference to the Glossarydex by a user will bring back almost instant memory and recall actions to be taken.

Frustrations for the user frequently result from the lack of working knowledge of computer software definitions and operations, and are usually not the result of their own ability to process their own field of endeavor. A uniform system such as that used by The Common Format Learning Device will enable the user to concentrate on their work, rather than on computer frustrations that divert their attention away from their work.

Foreign Languages are compatible with The Common Format Learning Device, as they are entered into graphic text exactly as they are presented here in the Standard English language.

The Common Format Learning Device may, in some embodiments, have different versions that are directed at the skill level of the user. For example, the Beginner Version is for a user who is easily frustrated because of their lack of general computer knowledge, and only need to know and have use for the simplest computer operations. After the beginner version user has read the introduction, they should be able to follow through on a simple Common Format Learning Device operation after trying one or two times.

People differ greatly in their need, amount and degree of learning they think they might require. This is partially based on the software or proposed use of the software, given that there are ail degrees of human minds for applications to computer software. The Common Format Learning Devices are designed and printed for an individual's learning orientation so the user can pre-select one of several degrees of complexity and one of several hardware approaches. The Professional version, for example, is the full copy of The Common Format Learning Device and both the Intermediate Version and the Beginner Version are selected from it.

The Intermediate Version is intended for users in business, government, organizations, etc. who have a need for more advanced approaches and details to support their work day use of software.

The Professional Version is intended for those users whose job calls them by occupation and education to seek the highest and most detailed computer software operations. People in this category have often times studied computer software in high school and/or college, or have studied in related fields of software programming, information technology, science, and engineering.

In addition to the skill level of the user, there are various hardware approaches to the Common Format Learning Device. For example, the Keyboard version is for users who are out of high school recently, and have taken computer and keyboarding in school. Included in this group also are older people of any age who learned keyboarding in school on typewriters and used this skill in their work lives.

The Mouse Version is for users who use the “hunt and peck” system at the keyboard, as they never had the opportunity to study keyboarding. These people very efficiently use computers in business at automatic sales registers, inventory control, etc. They are also the “frustrated” computer users in middle and upper management who refuse to acknowledge that the computer exists. These people depend mostly on the mouse for their software attack, frequently use the Microsoft “givens” like the mouse, and use preformatted “Forms” and icons to help them along.

The Audio version is coming info wider usage by both middle and upper management users who have never studied or used software applications on the computer. Audio technology voice conversion software applications are now reasonable solutions for these users.

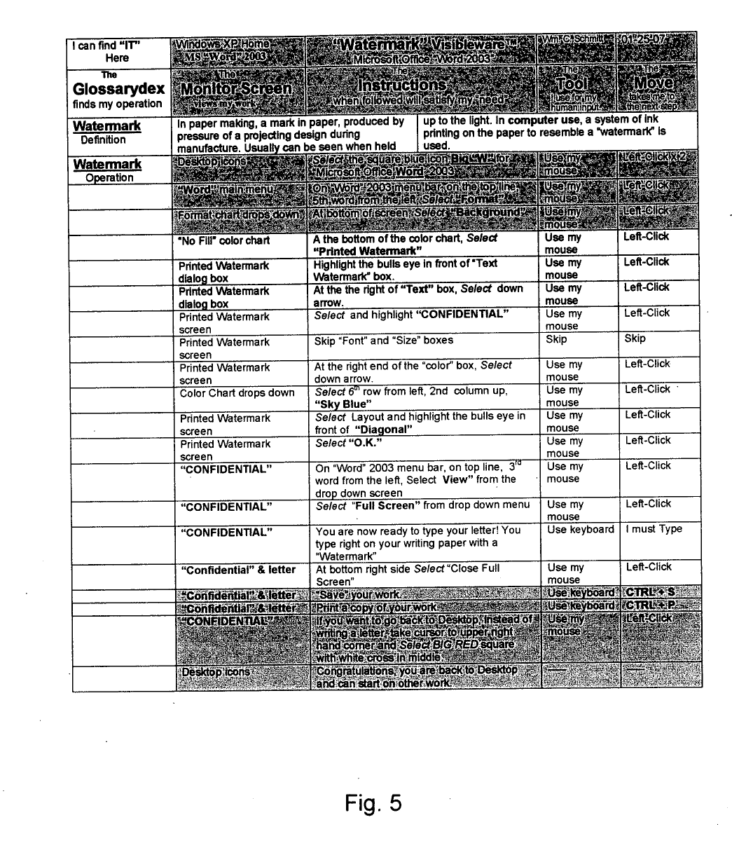

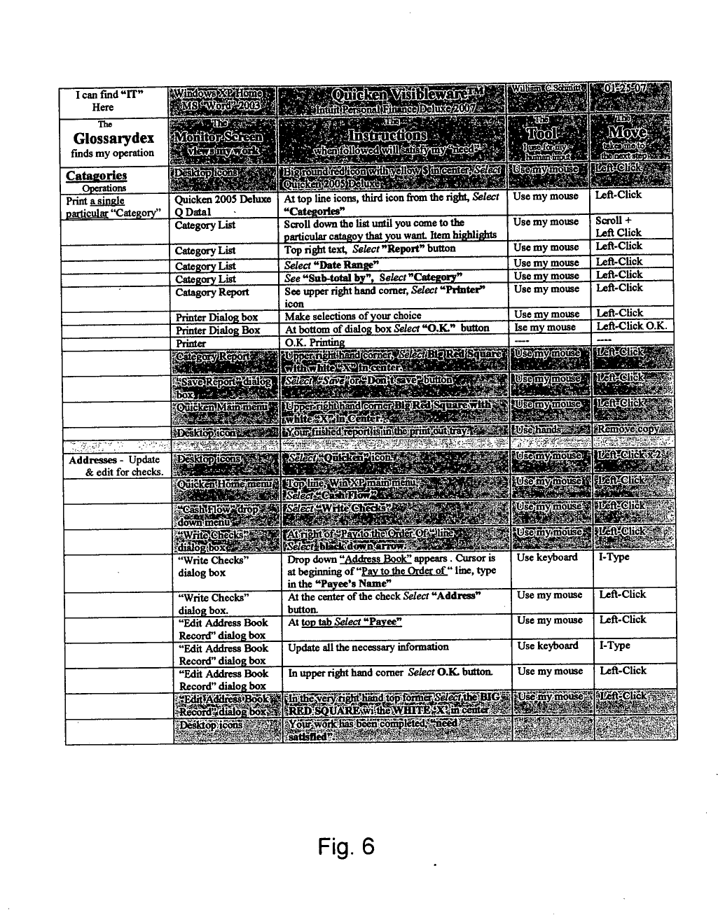

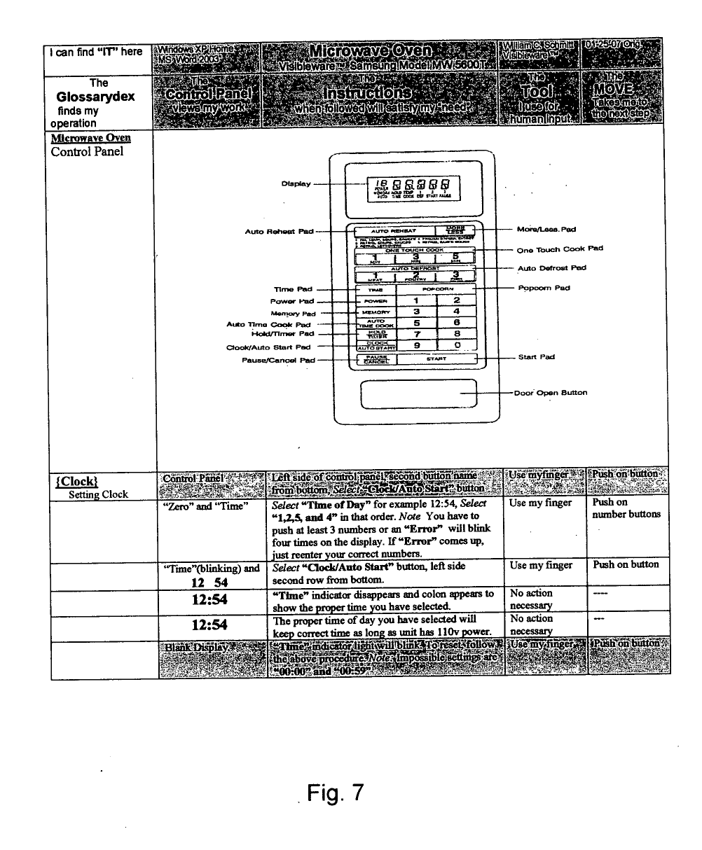

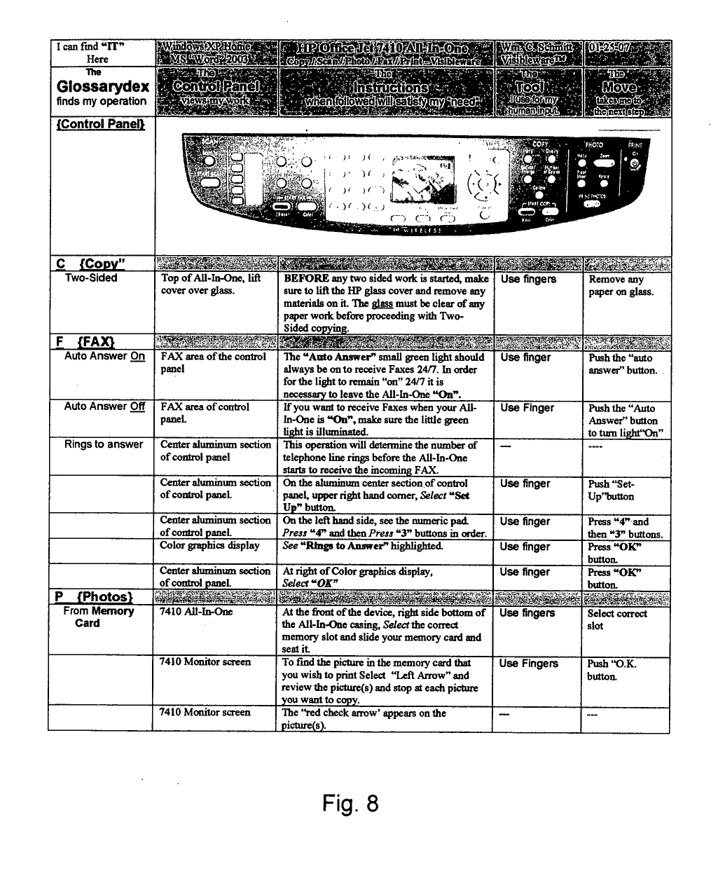

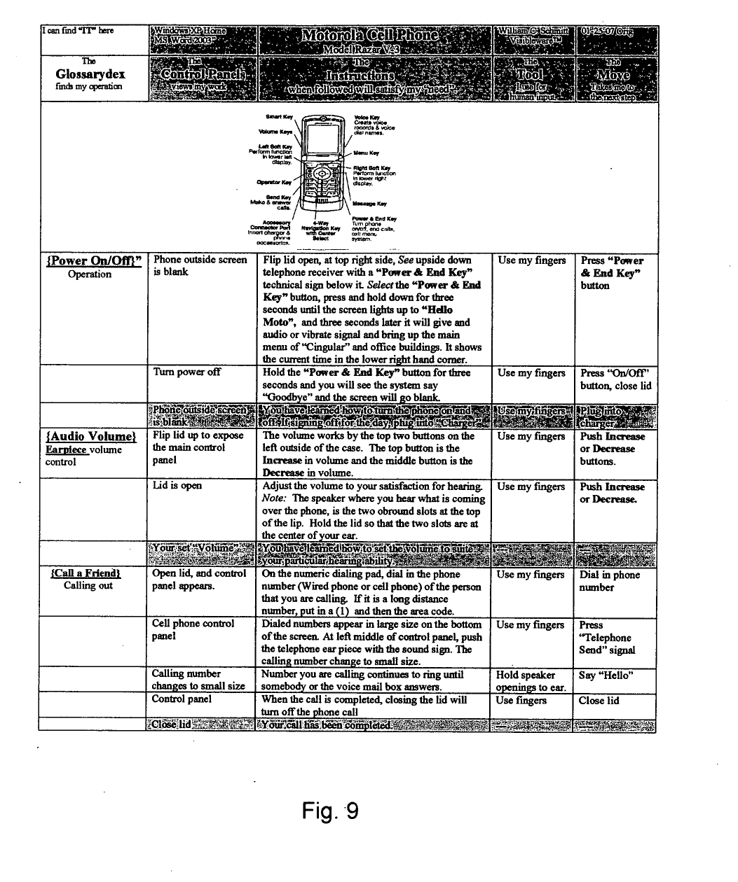

Referring lastly to various examples of the Common Format Learning Device of the present invention, FIG. 4 shows an example of the Common Format Learning Device using Kodak Easy Share Software. FIG. 5 shows an example of the Common Format Learning Device using the “Watermark” function of Microsoft Word. FIG. 6 shows an example of the Common Format Learning Device using Quicken personal finance software. FIG. 7 shows an example of the Common Format Learning Device using a microwave oven electronic interface as an example. FIG. 8 shows an example of the Common Format Learning Device using an all-in-one electronic copier as an example. FIG. 9 shows an example of the Common Format Learning Device using a cell phone electronic interface as an example. These examples are meant to help one skilled in the art to make and use the invention, and are not meant to in any way limit the scope or application of the Common Format Learning Device. To use the Common Format Learning Device of the present invention, read the Operation starting with the first line of The Common Format Learning Device, and read left to right the four columns. After the Move Command, drop down to the next interactive line and start at the left end again. Color format will help one to not only use the present invention, but will also improve memory retention. Other color schemes and patterns may be used in various embodiments of the present invention, without departing from the spirit and scope of the invention as defined by this specification.

### A comparison of the Common Format Learning Device Teaching/Learning vs. Generic “Prior Art” Teaching/Learning

| The Common Format Learning Device | Prior Art and other teaching courses, |
|---|---|
| teaching/learning | videos, etc. |
| THE COMMON FORMAT LEARNING DEVICE | NO EMULATION of software known from Desk Top |
| emulates the original programmers' logic and software. | to Desktop. Usually one or more of the necessary chess |
| Every human's logic is different from all others. The | moves are missing, or given in incorrect order, or |
| Common Format Learning Device of the present | misunderstood, so trying to satisfy the “need” is |
| invention(tm) makes seemingly incomprehensible | difficult and frustrating.. |
| programming logic understandable for the individual | |
| user's human mind. | |
| The Common Format Learning Device is individual | No Other Interactive cycle is known in teaching and |
| interactive four step action cycles from the Monitor | learning of software applications |
| Screen, Instruction Guide, Human Input and the Execute | |
| Command. Each cycle is presented in turn and each | |
| requires a user response to complete the total interactive | |
| operation. | |
| THE COMMON FORMAT LEARNING DEVICE is | HIDE & GO SEEK - is the norm for software |
| the visible presentation of what the soft ware programmer | programmers as they present the user with hidden |
| has programmed. | selections and actions, screens buried three levels deep |
| Bringing the invisible to visible ! | in software; and non-explanation of use of computer |
| | terms. |
| UNIFORM GUIDANCE SYSTEM. By showing how to | HUMAN CONCENTRATION - Many times other |
| perform the fully formatted operation in logical sequence, | teaching methods break the concentration by |
| it is possible for the user to stay concentrated on what | introducing the use of insignificant topics while trying |
| they are doing. There is no lost time or motion in | to teach a very detail and difficult topic, which breaks |
| following the operation from start to finish. | the concentration. Verbal instructions in the class room |
| | in particular are subject to off hand remarks to break |
| | the concentration. |
| MEMORY TARGETED. Human memory is the normal | CONFUSED MEMORY results from seeking all |
| way humans work on computers with related software and | kinds of help in trying to get answers for the necessary |
| practically all other high tech applications. The Common | knowledge to solve the users' “need”. For the human |
| Format Learning Device structures the minimum accurate | mind to keep all the minutely detailed operations that |
| knowledge to directly satisfy the “need”. | they may want to use at the ready, is an almost |
| | impossible task |
| CHART FORMAT. - Provides a simple, direct | EXCESS WORDS are used by all other methods of |
| methodology for presentation of complicated and detailed | teaching, which leads to diversions for the mind and |
| technology. All of the presentations are developed onto a | confusion in learning. Extraneous words and sentences |
| common base and therefore makes it easier for the user to | are sometimes included, which add nothing to the |
| follow. | learning process. |
| COLOR is used one hundred percent in The Common | COLOR use is mostly seen in teaching texts when the |
| Format Learning Device and is part of the language and | basic method used is to replicate the actual colored |
| format to differentiate and teach by eye contact what part | screen products by the software, or in rare cases to |
| of the work the user is on. This additive of complete color | bring attention to a particular point of emphasis. Black |
| increases the ease of learning, retention and understanding | and white text often replaces the actual colored screen |
| | produced by the software to gray tone, which makes for |
| | a very dull presentation. |
| DEFINITIONS* - contain both common Dictionary and | DEFINITIONS - are usually contained in separate |
| “computerease” language, glossary, phrases, synonyms, | computer or Webster type dictionaries, a glossary and |
| cross index, icons and pictures to transfer knowledge to | maybe even a separate acronym book. Many times the |
| the user in the easiest manner.. | user goes along in ignorance with computer words or |
| | phrases as it is too much trouble to look up information |
| OPERATIONS. The beginning learner starts at Desk | OPERATIONS - The user most of the time is given |
| Top using the Glossarydex and proceeds directly to the | the starting point of the operation itself, with not the |
| shell of the Operation to solve the human “need”, and | slightest indication of how to get to the start of the |
| then the operation returns the learner back to Desk | operation when the computer is turned on. The “Help” |
| | information usually has to be printed out in hard copy |
| | in order to follow the whole procedure. |
| Stand-Alone - Each operation is complete in itself with | Contingent Support - No need to check a chapter, |
| no further reference or reliance on any other operation. | attend a classroom or search unnecessary information |
| You getuse and learn only what you need to solve your | to satisfy the need. Many times your particlar work is |
| requirements, nothing more. | dependent some previous noted work. |
| TEACHER/LEARNER. - With The Common Format | TEACHER - and its method of presentation, whether |
| Learning Device of the present invention(tm) the user is | classroom, book, video or whatever is presented in all |
| both teacher and learner. This means that the user as | cases for the run-of-the-mill or average user and must |
| “teacher” has full disclosure of the required technology of | cover all kinds of operations to present much |
| the operation, and the user as “learner” has the full use of | information that the user will never use, but fill the |
| the operation as presented | mind with unnecessary clutter. |
| Whatever “operation” the user selects to solve their | LEARNER - at best can only put to mind a |
| “need”, it is evident that the user has full capability to | diminished amount of “learning” because anything they |
| complete the operation and satisfy their need. | use for support of the original learning is different. |
| HIGHEST ACCURACY. - Exact repetition leads to | ACCURACY FORGOTTEN - Very seldom does any |
| the most rapid exact rote(memory retention) learning. | instructions have a high degree of accuracy in |
| | repetition, as most do not carry through with exact |
| | mind travel, due to the nature of the presentation of |
| | operations. |
| GLOSSARYDEX. - By use of the Glossarydex the user | DIFFICULT ACCESS - The user usually looks |
| is led directly to the definition or operation for easy | through the index, or looks for the chapter where the |
| access to start satisfying the human “need”. | item may be located, and proceeds to figure out |
| Most kindergarden graduates know the A–Z alphabet | through the wording, pictures etc how to solve the |
| | problem. |
| ONE WAY IS MY WAY* - Only ONE WAY is | MANY WAYS ARE THEIR WAYS - If two or three |
| presented for each operation to solve the “need”. Learn | ways are presented to perform the operation, the user |
| one way well, and forget all the confusion of alternate | will fill his mind with more confusion and add more |
| ways. | “operations” than necessary to get the work done. |
| DUAL SOFTWARE/THE COMMON FORMAT | USER PROFICIECY of operations in normal use is a |
| LEARNING DEVICE when The Common Format | very low percentage of the possible operations |
| Learning Device is programmed along with and by the | presented. |
| software producer can supply the user with a selection of | |
| random operations of over 95% success to to satisfy the | |
| user's “need”. | |
| DATE LINE. - The Common Format Learning Device is | DATE LINE - Books, videos and teaching materials |
| never out of date when purchased. as it is stored in | are out of date by the time the end user purchases the |
| electronic media and printed out for the individual | service. |
| purchaser; it is printed to his particular specifications, | It is not unusual in retail outlets to find printed |
| degree of learning and equipment on hand. | computer information well over two years old on the |
| | shelves. |
| TIME VALUE* - To satisfy the original “Need”, the | TIME VALUE - With books, videos, or class room |
| The Common Format Learning Device uses definitions, | instruction the amount of time on the computer is a |
| operations and computer equipment concurrently for | very low percentage, as reading unnecessary wordage |
| one hundred percent usage toward the goal. Both time and | or verbal instruction takes the time and effort of the |
| motion are held at a minimum. | user. One student in a class may take up the time of all |
| | the others. |
| FOREIGN LANGUAGES are easily supported. The | PRINTED TEXT - The Common Format Learning |
| Common Format Learning Device written language is just | Device works equally well in any foreign language. |
| as clear to the foreigner as is English to the English user. | |
| Translation can be easy and accurate as the number of | |
| words used are very limited. | |
| IN A WORD Words are held minimum by using single | IN A WORD - Most books, videos and classroom |
| words, phrases, etc. but not necessarily sentences. All | instructions use an excess of words by using complete |
| Words as much as possible direct the user to icons, | sentences (with a lot of “fillers’), in a effort to explain |
| screens, and pictures, to keep the human eye on events as | or clarify the operation. Human hearing is not as |
| the eye is the best method for human learning. | receptive to learning as are the eyes. |
| “TEACH BY EXAMPLE” in the Common Format | Teach by Example is most commonly used in |
| Learning Device is relatively easy and a sure way for | classroom instructions or tutor work on a one-on-one |
| teaching/learning for the users who really have trouble | basis. |
| with computer work. | |

What is claimed is:

1. A common format learning device for learning commands to control electronic devices comprising:
a. a glossarydex search engine containing an indexed listing of topics;
b. a listing of definitions wherein each definition is linked to at least one topic in the glossarydex search engine;
c. a listing of operations wherein each operation is linked to at least one topic in the glossarydex search engine;
d. a listing of sub-operations cataloged below each operation wherein each listing of sub-operations is related to the operation under which the sub-operation is cataloged; and
e. color coding of topics, definitions, operations and sub-operations.

2. The common format learning device of claim 1 wherein the device is a visibly perceivable chart.

3. The common format learning device of claim 1 wherein the device resides as software on a computer.

4. The common format learning device of claim 1 wherein the device is perceivable on a computer screen.

5. The common format learning device of claim 1 further comprising a relational database.

6. The common format learning device of claim 1 wherein the device resides within an electronic device.

7. The common format learning device of claim 1 wherein the device emulates the operations of an electronic device.

8. The common format learning device of claim 1 wherein the device is perceivable on an electronic device display.

9. The common format learning device of claim 1, wherein the color coding is definable.

10. A method for learning commands to control electronic devices, the method comprising the steps of:
selecting a topic from a glossarydex search engine;
reviewing a definition associated with a selected topic;
validating that the selected topic has been correctly selected after reviewing the definition; and
executing an operation that is linked to the selected topic.

11. The method of claim 10, further including the step of executing a sub-operation that is cataloged below the operation that has been executed.

12. A glossarydex search engine for creating a common format to learning commands for controlling electronic devices, the glossarydex search engine comprising:
a. an indexed listing of topics;
b. a means for updating the indexed listing of topics;
c. a means for sorting the indexed listing of topics;
d. a link to a listing of definitions;
e. a link to a listing of operations; and
f. color coding of the topics, definitions, and operations.

13. The glossarydex search engine of claim 12, further comprising a link to a listing of suboperations.

14. The glossarydex search engine of claim 12, further comprising a link to a listing of operations that is in turn linked to a listing of suboperations.

15. The glossarydex search engine of claim 12, wherein the color coding is definable.

16. A computer system for learning commands to control electronic devices comprising:
a. a glossarydex search engine containing an indexed listing of topics;
b. a listing of definitions whereas each definition is linked to at least one topic in the search engine;
c. a listing of operations whereas each operation is linked to at least one topic in the search engine;
d. a listing of sub-operations cataloged below each operation whereas each listing of sub-operations is related to the operation under which the sub-operation is cataloged; and
e. color coding of topics, definitions, operations and sub-operations.

17. The computer system of claim 16, further comprising a relational database.

18. The computer system of claim 16, further comprising a visibly perceivable chart.

19. The computer system of claim 18, wherein the visibly perceivable chart is displayed on a computer screen

20. The computer system of claim 18, wherein the visibly perceivable chart is printed.

21. The computer system of claim 16, wherein the color coding is definable.
